(19) United States
(12) Patent Application Publication
(10) Pub. No.: US 2025/0035584 A1
(43) Pub. Date: Jan. 30, 2025

(54) CALCULATING ELECTROPHORETIC MOBILITY OF A SAMPLE BY EXTRACTING FREQUENCY SHIFT

(71) Applicant: Wyatt Technology, LLC, Goleta, CA (US)

(72) Inventors: Grzegorz M. Dmochowski, Goleta, CA (US); David Rahmlow, Goleta, CA (US); Steven P. Trainoff, Santa Barbara, CA (US); Shivakumar K. Ramini, Newbury Park, CA (US); Brett Hall, Goleta, CA (US)

(21) Appl. No.: 18/776,902

(22) Filed: Jul. 18, 2024

Related U.S. Application Data
(60) Provisional application No. 63/528,551, filed on Jul. 24, 2023.

(51) Int. Cl. G01N 27/447

(52) U.S. Cl. CPC G01N 27/44721; G01N 27/44756

(57) ABSTRACT

The present disclosure describes a method, system, and computer program product of calculating electrophoretic mobility of a sample by extracting frequency shift. In an embodiment, the method, system, and computer program product include receiving at least one frequency domain spectrum relating to light intensity detector data corresponding to a sample, truncating the spectrum to a region of interest, establishing a minimum fitter amplitude for what constitutes a peak, identifying possible distinct peaks in the region of interest, finding initial parameters for fitting at least one distinct peak among the possible distinct peaks, selecting a selected fitting model from among a plurality of fitting models with respect to the possible distinct peaks, and fitting the at least one distinct peak to the selected fitting model resulting in at least one fitted signal peak corresponding to the light intensity detector data, allowing for calculating electrophoretic mobility of particles in the sample.

### RELATED APPLICATION

This application claims priority to U.S. Provisional Patent Application No. 63/528,551 filed on Jul. 24, 2023 and titled “Calculating Electrophoretic Mobility of a Sample by Extracting Frequency Shift”, the entirety of which is incorporated by reference herein.

### BACKGROUND

The present disclosure relates to electrophoretic mobility, and more specifically, to calculating electrophoretic mobility of a sample by extracting frequency shift.

### SUMMARY

The present disclosure describes a computer implemented method, a system, and a computer program product of calculating electrophoretic mobility of a sample by extracting frequency shift. In an exemplary embodiment, the computer implemented method, the system, and the computer program product include (1) receiving, by a computer system, at least one frequency domain spectrum relating to light intensity detector data corresponding to a sample, (2) executing, by a computer system, a series of logical operations truncating the spectrum to a region of interest with respect to a spectrum center frequency associated with the spectrum, (3) executing, by the computer system, a series of logical operations establishing a minimum fitter amplitude for what constitutes a peak in the region of interest, (4) executing, by the computer system, a series of logical operations identifying possible distinct peaks in the region of interest with respect to the minimum fitter amplitude and a maximum amplitude value associated with the region of interest, (5) executing, by the computer system, a series of logical operations finding initial parameters for fitting at least one distinct peak among the possible distinct peaks with respect to the maximum amplitude value, (6) executing, by the computer system, a series of logical operations selecting a selected fitting model from among a plurality of fitting models with respect to the possible distinct peaks, and (7) executing, by the computer system, a series of logical operations fitting the at least one distinct peak to the selected fitting model resulting in at least one fitted signal peak corresponding to the light intensity detector data, allowing for calculating electrophoretic mobility of particles in the sample.

### BRIEF DESCRIPTION OF THE DRAWINGS

FIG. 1A depicts a flowchart in accordance with an exemplary embodiment.

FIG. 1B depicts a flowchart in accordance with an embodiment.

FIG. 2 depicts a flowchart in accordance with an embodiment.

FIG. 3 depicts a flowchart in accordance with an embodiment.

FIG. 4 depicts a flowchart in accordance with an embodiment.

FIG. 5 depicts a flowchart in accordance with an embodiment.

FIG. 6 depicts a graph in accordance with an embodiment.

FIG. 7A depicts a graph in accordance with an embodiment.

FIG. 7B depicts a graph in accordance with an embodiment.

FIG. 7C depicts a graph in accordance with an embodiment.

FIG. 8 depicts a computer system in accordance with an exemplary embodiment.

### DETAILED DESCRIPTION

The present disclosure describes a computer implemented method, a system, and a computer program product of calculating electrophoretic mobility of a sample by extracting frequency shift. In an exemplary embodiment, the computer implemented method, the system, and the computer program product include (1) receiving, by a computer system, at least one frequency domain spectrum relating to light intensity detector data corresponding to a sample, (2) executing, by a computer system, a series of logical operations truncating the spectrum to a region of interest with respect to a spectrum center frequency associated with the spectrum, (3) executing, by the computer system, a series of logical operations establishing a minimum fitter amplitude for what constitutes a peak in the region of interest, (4) executing, by the computer system, a series of logical operations identifying possible distinct peaks in the region of interest with respect to the minimum fitter amplitude and a maximum amplitude value associated with the region of interest, (5) executing, by the computer system, a series of logical operations finding initial parameters for fitting at least one distinct peak among the possible distinct peaks with respect to the maximum amplitude value, (6) executing, by the computer system, a series of logical operations selecting a selected fitting model from among a plurality of fitting models with respect to the possible distinct peaks, and (7) executing, by the computer system, a series of logical operations fitting the at least one distinct peak to the selected fitting model resulting in at least one fitted signal peak corresponding to the light intensity detector data, allowing for calculating electrophoretic mobility of particles in the sample. In an embodiment, the spectrum is devoid of data artifacts due to at least one of noise in the intensity detector data, stitching of parts of the intensity detector data, and phase discontinuities in the intensity detector data. In an embodiment, the minimum fitter amplitude is used to flag false positives for parts of the spectrum corresponding to a peak that could be identified by the fitting (e.g., false positives caused by spurious noise or dirt). In an embodiment, the initial fitting parameters provide starting points or guesses for the fitting.

### Definitions

### Particle

A particle may be a constituent of a liquid sample aliquot. Such particles may be molecules of varying types and sizes, nanoparticles, virus like particles, liposomes, emulsions, bacteria, and colloids. These particles may range in size on the order of nanometer to microns. Analysis of Macromolecular or Particle Species in Solution

The analysis of macromolecular or particle species in solution may be achieved by preparing a sample in an appropriate solvent and then injecting an aliquot thereof into a separation system such as a liquid chromatography (LC) column or field flow fractionation (FFF) channel where the different species of particles contained within the sample are separated into their various constituencies. Once separated generally based on size, mass, or column affinity, the samples may be subjected to analysis by means of light scattering, refractive index, ultraviolet absorption, electrophoretic mobility, and viscometric response.

### Light Scattering

Light scattering (LS) is a non-invasive technique for characterizing macromolecules and a wide range of particles in solution. The two types of light scattering detection frequently used for the characterization of macromolecules are static light scattering and dynamic light scattering.

### Dynamic Light Scattering

Dynamic light scattering is also known as quasi-elastic light scattering (QELS) and photon correlation spectroscopy (PCS). In a DLS experiment, time-dependent fluctuations in the scattered light signal are measured using a fast photodetector. DLS measurements determine the diffusion coefficient of the molecules or particles, which can in turn be used to calculate their hydrodynamic radius.

### Static Light Scattering

Static light scattering (SLS) includes a variety of techniques, such as single angle light scattering (SALS), dual angle light scattering (DALS), low angle light scattering (LALS), and multi-angle light scattering (MALS). SLS experiments generally involve the measurement of the absolute intensity of the light scattered from a sample in solution that is illuminated by a fine beam of light. Such measurement is often used, for appropriate classes of particles/molecules, to determine the size and structure of the sample molecules or particles, and, when combined with knowledge of the sample concentration, the determination of weight average molar mass. In addition, nonlinearity of the intensity of scattered light as a function of sample concentration may be used to measure interparticle interactions and associations.

### Multi-Angle Light Scattering

Multi-angle light scattering (MALS) is a SLS technique for measuring the light scattered by a sample into a plurality of angles. It is used for determining both the absolute molar mass and the average size of molecules in solution, by detecting how they scatter light. Collimated light from a laser source is most often used, in which case the technique can be referred to as multiangle laser light scattering (MALLS). The “multi-angle” term refers to the detection of scattered light at different discrete angles as measured, for example, by a single detector moved over a range that includes the particular angles selected or an array of detectors fixed at specific angular locations.

A MALS measurement requires a set of ancillary elements. Most important among them is a collimated or focused light beam (usually from a laser source producing a collimated beam of monochromatic light) that illuminates a region of the sample. The beam is generally plane-polarized perpendicular to the plane of measurement, though other polarizations may be used especially when studying anisotropic particles. Another required element is an optical cell to hold the sample being measured. Alternatively, cells incorporating means to permit measurement of flowing samples may be employed. If single-particles scattering properties are to be measured, a means to introduce such particles one-at-a-time through the light beam at a point generally equidistant from the surrounding detectors must be provided.

Although most MALS-based measurements are performed in a plane containing a set of detectors usually equidistantly placed from a centrally located sample through which the illuminating beam passes, three-dimensional versions also have been developed where the detectors lie on the surface of a sphere with the sample controlled to pass through its center where it intersects the path of the incident light beam passing along a diameter of the sphere. The MALS technique generally collects multiplexed data sequentially from the outputs of a set of discrete detectors. The MALS light scattering photometer generally has a plurality of detectors.

Normalizing the signals captured by the photodetectors of a MALS detector at each angle may be necessary because different detectors in the MALS detector (i) may have slightly different quantum efficiencies and different gains, and (ii) may look at different geometrical scattering volumes. Without normalizing for these differences, the MALS detector results could be nonsensical and improperly weighted toward different detector angles.

### Electrophoretic Light Scattering

Electrophoretic light scattering (ELS) is a technique used to measure the electrophoretic mobility of particles in dispersion, or molecules in solution. This mobility is often converted to Zeta potential to enable comparison of materials under different experimental conditions. The fundamental physical principle is that of electrophoresis. A dispersion is introduced into a cell containing two electrodes. An electrical field is applied to the electrodes, and particles or molecules that have a net charge, or more strictly a net zeta potential will migrate towards the oppositely charged electrode with a velocity, known as the mobility, that is related to their zeta potential.

When an electric field is applied to a sample, any charged objects in the sample will be influenced by that field. The extra movement that particles exhibit as a result of them experiencing the electric field is called the electrophoretic mobility. Its typical units are μm·cm/V·s (micrometer centimeter per Volt second) since it is a velocity [μm/s] per field strength [V/cm]. The electrophoretic mobility is the direct measurement from which the zeta potential can be derived (using either the Smoluchowski/Debye-Hückel approximations or the complete Henry function F(κa) to get from the mobility to a zeta potential).

Electrophoretic light scattering (ELS) involves applying an electric field to the sample in order to exert a force on the (charged) particles. In order to prevent the accumulation of charged particles onto the electrodes used to establish this electric field in an ELS measurement instrument, an alternating field is used, whose direction is switched (e.g., between positive and negative directions) rapidly enough to prevent charge build-up. During the application of a positive electric field, the sample acquires a positive velocity component, which leads to a positive Doppler frequency shift on the light that is scattered from the sample. During the application of a negative electric field, the sample acquires a velocity component in the opposite direction, which leads to a negative Doppler shift on the light that is scattered from the sample.

### Data Fitting

Data fitting fits mathematical models/functions to data and analyzes the accuracy of the fit. Data fitting techniques, including mathematical equations and nonparametric methods, may model data acquired by measurement devices/instruments.

### Gaussian Function Fitting

The Gaussian function is symmetric about its center point, has a finite integral, and is such that it does not have exceedingly large tails or other components that extend out to a significant degree. The Gaussian function/curve is the classic “bell-shaped” or “normal” curve/distribution.

### Lorentzian Function Fitting

The Lorentzian function also is symmetric about its center point, has a finite integral, and is such that it does not have exceedingly large tails or other components that extend out to a significant degree. However, the Lorentzian function/curve is somewhat narrower around its maximum and it extends out a little more than the Gaussian on its sides (i.e., the Lorentzian function/curve has “wings”. The Lorentzian function is used for pre-processing of the background in a spectrum and for fitting of the spectral intensity. Real spectral shapes are better approximated by the Lorentzian function than the Gaussian function.

### Smoothing

Smoothing is the process of removing noise from raw a input signal. Several techniques exist, from simple to more complicated. For example, moving average smoothing remove noises by taking the simple mean or average of data, with respect to a window length (number of data points that should be included in the average). As another example, Savitsky-Golay removes noise from a signal by locally fitting a least squares polynomial to the data and using the value of the fitted polynomial at the center point as the smoothed value. LOWESS smoothing (LOcally WEighted Scatterplot Smoothing) computes a regression line through the neighborhood for each data point and weights the points based on their distance to the central point, using local linear regression. LOESS is a generalization of LOWESS to multiple dimensions and higher degree polynomials, using local quadratic polynomial regression.

### Sum of Squared Residual

The sum of squared residual (SSR) or residual sum of squares (RSS) is a statistical method that helps identify the level of discrepancy in a dataset not predicted by a regression model. Thus, it measures the variance in the value of the observed data when compared to its predicted value as per the regression model. Hence, SSR/RSS indicates whether the regression model fits the actual dataset well or not. The SSR/RSS is obtained by adding the square of residuals. Residuals are projected deviations from actual data values and represent errors in the regression model's estimation. A lower SSR indicates that the regression model fits the data well and has minimal data variation.

### Sum of Squared Error

The sum of squared error (SSE) is the sum of the squared differences between each observation in a data set and the data set's mean value. The SSE for a data set can be used as a measure of variation within the data set/data cluster. If all cases within the data set/data cluster were identical, then the SSE would equal 0.

### Current Technologies

Current ELS measurement instruments typically switch the electric field at a frequency of 20 Hz, such that the original time domain data has alternating 50 ms segments, each of which have either a positive or a negative frequency shift imprinted on it. The frequency domain representation (i.e., the “spectrum” or the Fast Fourier Transform) of this entire stretch of data would then have both frequency shifts imprinted on it, which leads to more difficult fitting and the inability to detect the sign of the charge of the sample. There is a need to extract a frequency shift from the frequency domain data/spectrum, where the shift is then then translated into an ELS measurement. Thus, there is a need for calculating electrophoretic mobility of a sample by extracting a frequency shift in the spectrum.

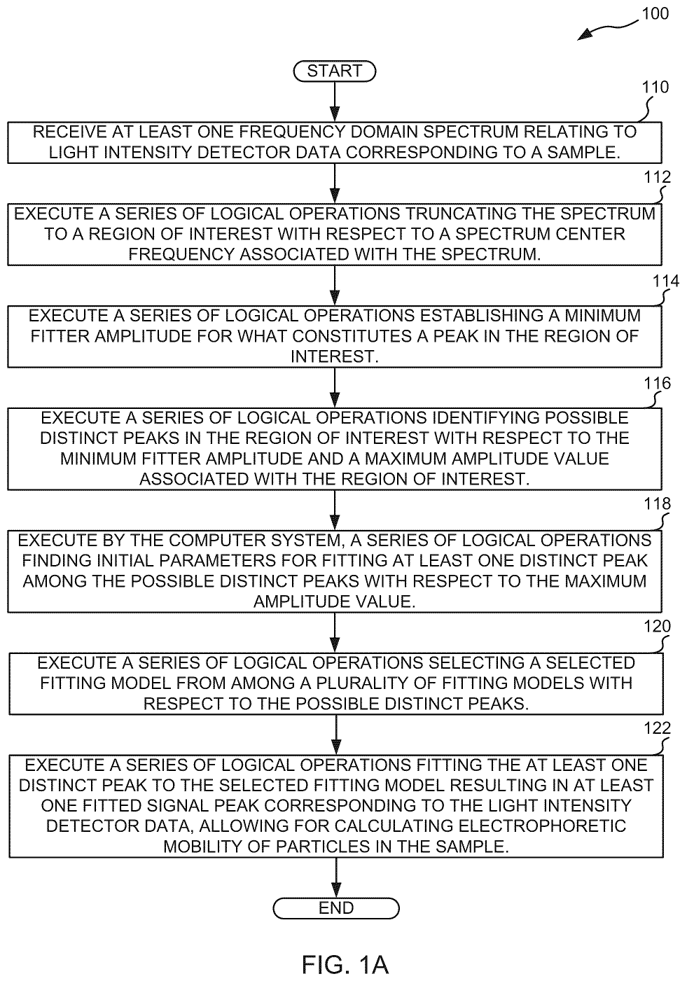

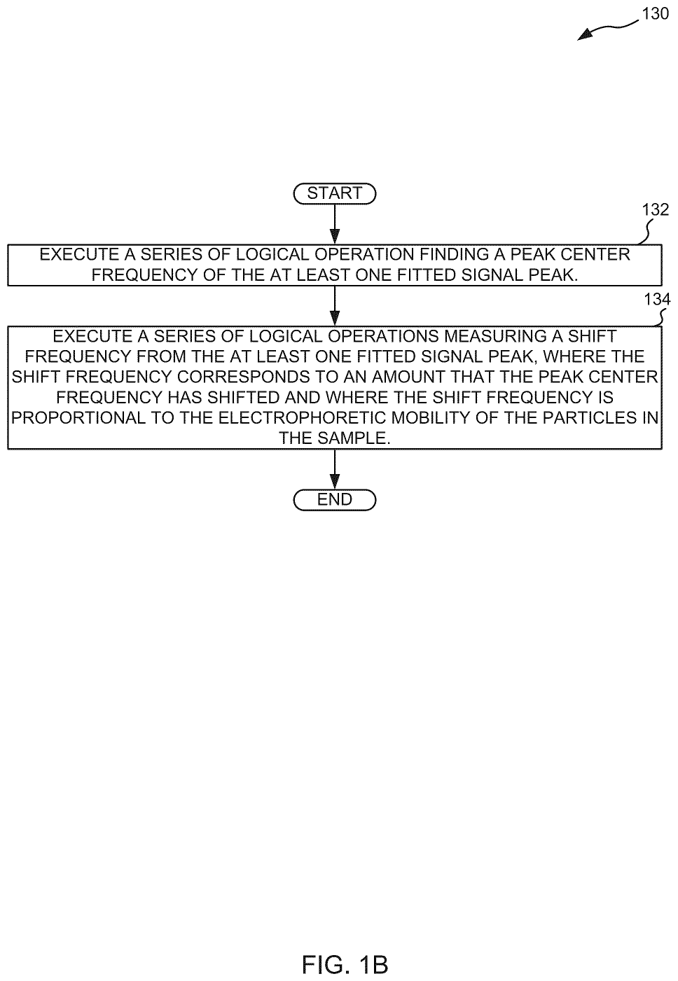

Referring to FIG. 1A, in an exemplary embodiment, the computer implemented method, the system, and the computer program product are configured to perform an operation 110 of receiving, by a computer system, at least one frequency domain spectrum relating to light intensity detector data corresponding to a sample, an operation 112 of executing, by a computer system, a series of logical operations truncating the spectrum to a region of interest with respect to a spectrum center frequency associated with the spectrum, an operation 114 of executing, by the computer system, a series of logical operations establishing a minimum fitter amplitude for what constitutes a peak in the region of interest, an operation 116 of executing, by the computer system, a series of logical operations identifying possible distinct peaks in the region of interest with respect to the minimum fitter amplitude and a maximum amplitude value associated with the region of interest, an operation 118 of executing, by the computer system, a series of logical operations finding initial parameters for fitting at least one distinct peak among the possible distinct peaks with respect to the maximum amplitude value, an operation 120 of executing, by the computer system, a series of logical operations selecting a selected fitting model from among a plurality of fitting models with respect to the possible distinct peaks, and an operation 122 of executing, by the computer system, a series of logical operations fitting the at least one distinct peak to the selected fitting model resulting in at least one fitted signal peak corresponding to the light intensity detector data, allowing for calculating electrophoretic mobility of particles in the sample.

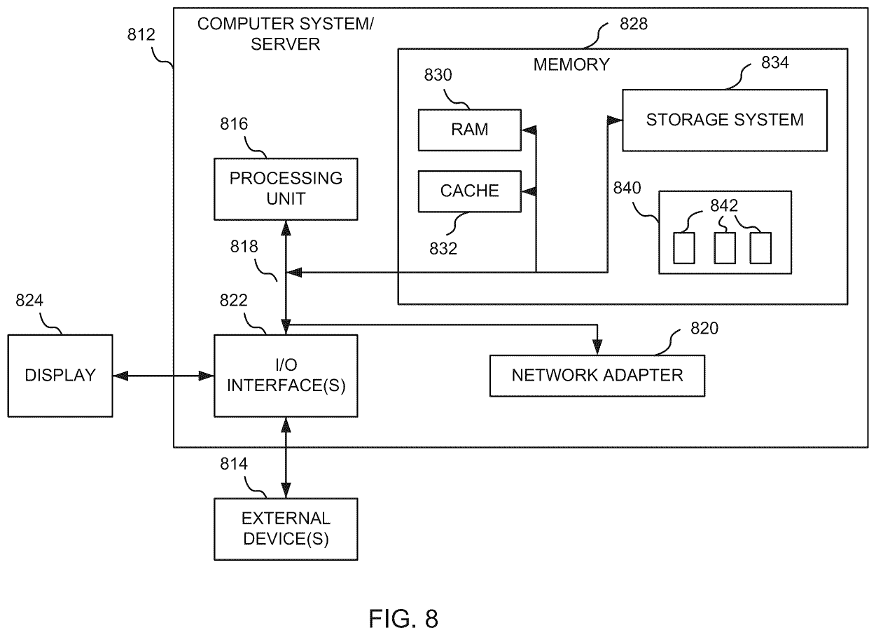

In an exemplary embodiment, the computer system is a standalone computer system, such as computer system 800 shown in FIG. 8, a network of distributed computers, where at least some of the computers are computer systems such as computer system 800 shown in FIG. 8, or a cloud computing node server, such as computer system 800 shown in FIG. 8. In an embodiment, the computer system is a computer system 800 as shown in FIG. 8, that executes a calculating electrophoretic mobility of a sample script or computer software application that carries out the operations of at least method 100. In an embodiment, the computer system is a computer system/server 812 as shown in FIG. 8, that executes a calculating electrophoretic mobility of a sample script or computer software application that carries out the operations of at least method 100. In an embodiment, the computer system is a processing unit 816 as shown in FIG. 8, that executes a calculating electrophoretic mobility of a sample script or computer software application that carries out the operations of at least method 100.

In an embodiment, the computer system is a computer system 800 as shown in FIG. 8, that executes a calculating electrophoretic mobility of a sample script or computer software application that carries out at least operations 110, 112, 114, 116, 118, 120, and 122. In an embodiment, the computer system is a computer system/server 812 as shown in FIG. 8, that executes a calculating electrophoretic mobility of a sample script or computer software application that carries out at least operations 110, 112, 114, 116, 118, 120, and 122. In an embodiment, the computer system is a processing unit 816 as shown in FIG. 8, that a calculating electrophoretic mobility of a sample script or computer software application that carries out at least operations 110, 112, 114, 116, 118, 120, and 122.

### Region of Interest

In an embodiment, the region of interest includes parts of the spectrum having frequencies, fᵣₒᵢ, greater than a sum of the spectrum center frequency, f_{c}, and a boundary frequency, f_{b}, and having frequencies less than a difference between the spectrum center frequency, f_{c}, and the boundary frequency, f_{b}, where the boundary frequency is less than a shift frequency, fₛₕ, associated with the spectrum. For example, the region of interest includes parts of the spectrum having frequencies, fᵣₒᵢ, such that

$${f}_{c} - {f}_{b} < {f}_{r o i} , < {f}_{c} + {f}_{b} ,$$

where f_{b}<fₛₕ.
   In an embodiment, the boundary frequency, f_{b}, is less than one-half of the shift frequency, fₛₕ. For example, the boundary frequency, f_{b}, is 300 Hz to 650 Hz, on either side of the center frequency, f_{c}.

### Calculating Electrophoretic Mobility

In a further embodiment, the calculating the electrophoretic mobility includes (a) executing, by the computer system, a series of logical operations finding a peak center frequency of the at least one fitted signal peak, and (b) executing, by the computer system, a series of logical operations measuring a shift frequency from the at least one fitted signal peak, where the shift frequency corresponds to an amount that the peak center frequency has shifted and where the shift frequency is proportional to the electrophoretic mobility of the particles in the sample. Referring to FIG. 1B, in a further embodiment, the calculating the electrophoretic mobility includes an operation 132 of executing, by the computer system, a series of logical operations finding a peak center frequency of the at least one fitted signal peak, and an operation 134 of executing, by the computer system, a series of logical operations measuring a shift frequency from the at least one fitted signal peak, where the shift frequency corresponds to an amount that the peak center frequency has shifted and where the shift frequency is proportional to the electrophoretic mobility of the particles in the sample.

In an embodiment, the computer system is a computer system 800 as shown in FIG. 8, that executes a purifying a sample solution via real-time multi-angle light scattering script or computer software application that carries out the operations of at least method 130. In an embodiment, the computer system is a computer system/server 812 as shown in FIG. 8, that executes a purifying a sample solution via real-time multi-angle light scattering script or computer software application that carries out the operations of at least method 130. In an embodiment, the computer system is a processing unit 816 as shown in FIG. 8, that executes a purifying a sample solution via real-time multi-angle light scattering script or computer software application that carries out the operations of at least method 130.

In an embodiment, the computer system is a computer system 800 as shown in FIG. 8, that executes a calculating electrophoretic mobility of a sample script or computer software application that carries out at least operations 132 and 134. In an embodiment, the computer system is a computer system/server 812 as shown in FIG. 8, that executes a calculating electrophoretic mobility of a sample script or computer software application that carries out at least operations 132 and 134. In an embodiment, the computer system is a processing unit 816 as shown in FIG. 8, that a calculating electrophoretic mobility of a sample script or computer software application that carries out at least operations 132 and 134.

### Establishing Minimum Fitter Amplitude

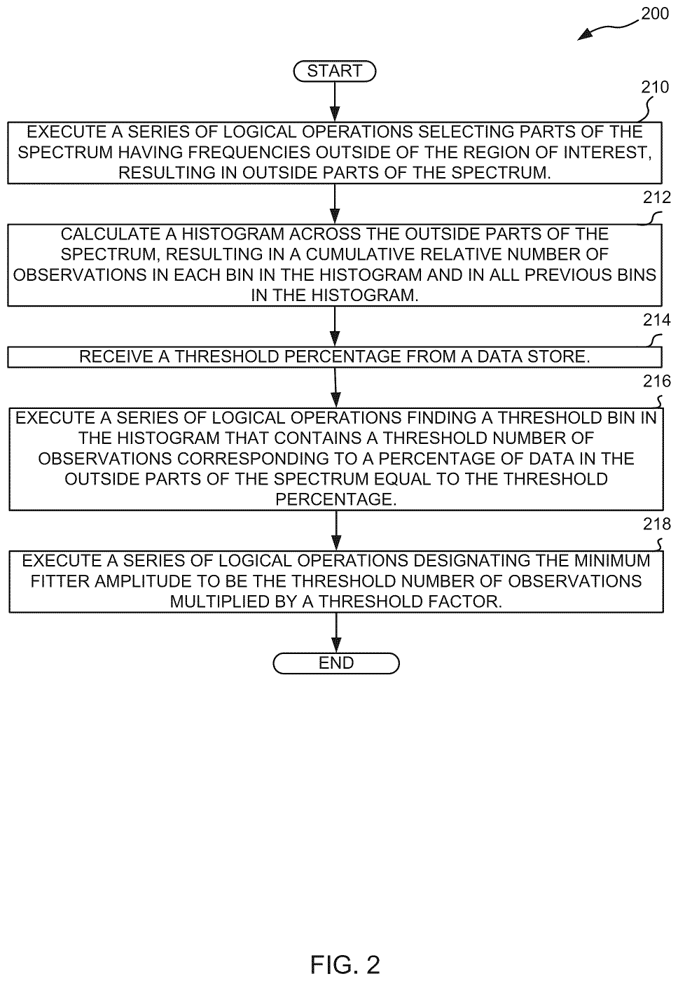

In an embodiment, the establishing the minimum fitter amplitude includes (a) executing, by the computer system, a series of logical operations selecting parts of the spectrum having frequencies outside of the region of interest, resulting in outside parts of the spectrum, (b) calculating, by the computer system, a histogram across the outside parts of the spectrum, resulting in a cumulative relative number of observations in each bin in the histogram and in all previous bins in the histogram, (c) receiving, by the computer system, a threshold percentage from a data store, (d) executing, by the computer system, a series of logical operations finding a threshold bin in the histogram that contains a threshold number of observations corresponding to a percentage of data in the outside parts of the spectrum equal to the threshold percentage, and (e) executing, by the computer system, a series of logical operations designating the minimum fitter amplitude to be the threshold number of observations multiplied by a threshold factor. Referring to FIG. 2, in an embodiment, establishing operation 114 includes an operation 210 of executing, by the computer system, a series of logical operations selecting parts of the spectrum having frequencies outside of the region of interest, resulting in outside parts of the spectrum, an operation 212 of calculating, by the computer system, a histogram across the outside parts of the spectrum, resulting in a cumulative relative number of observations in each bin in the histogram and in all previous bins in the histogram, an operation 214 of receiving, by the computer system, a threshold percentage from a data store, an operation 216 of executing, by the computer system, a series of logical operations finding a threshold bin in the histogram that contains a threshold number of observations corresponding to a percentage of data in the outside parts of the spectrum equal to the threshold percentage, and an operation 218 executing, by the computer system, a series of logical operations designating the minimum fitter amplitude to be the threshold number of observations multiplied by a threshold factor. In an embodiment, the data store is at least one of a database, computer code, and user input. In an embodiment, the histogram contains cumulative observations in each of its bins. In an embodiment, the threshold factor is 5.

In an embodiment, the region of interest includes enough data points to indicate the noise level of the background environment of the light intensity detector (e.g., 1000-points long) and to find typical noise power in a histogram bin far away from a peak in the spectrum. In an embodiment, the calculating does not return the count of each bin in the histogram, but, instead returns the number of bins having noise levels lower than a first noise level, X, and the number of bins having noise levels lower than a second noise level, Y (i.e., a noise histogram of data on the wings/edges of the spectrum).

In an embodiment, the threshold percentage is within a range of 95% to 100%. For example, the threshold percentage is 98%. In an embodiment, the threshold bins contains enough data such that 98% of the data in the spectrum has values no larger than the data in the threshold bin. In an embodiment, the minimum fitter amplitude is set to minimize false positives and to approximate the amplitude of the first big peak spectrum.

In an embodiment, the computer system is a computer system 800 as shown in FIG. 8, that executes a purifying a sample solution via real-time multi-angle light scattering script or computer software application that carries out the operations of at least method 200. In an embodiment, the computer system is a computer system/server 812 as shown in FIG. 8, that executes a purifying a sample solution via real-time multi-angle light scattering script or computer software application that carries out the operations of at least method 200. In an embodiment, the computer system is a processing unit 816 as shown in FIG. 8, that executes a purifying a sample solution via real-time multi-angle light scattering script or computer software application that carries out the operations of at least method 200.

In an embodiment, the computer system is a computer system 800 as shown in FIG. 8, that executes a calculating electrophoretic mobility of a sample script or computer software application that carries out at least operations 210, 212, 214, 216, and 218. In an embodiment, the computer system is a computer system/server 812 as shown in FIG. 8, that executes a calculating electrophoretic mobility of a sample script or computer software application that carries out at least operations 210, 212, 214, 216, and 218. In an embodiment, the computer system is a processing unit 816 as shown in FIG. 8, that a calculating electrophoretic mobility of a sample script or computer software application that carries out at least operations 210, 212, 214, 216, and 218.

### Identifying Possible Distinct Peaks

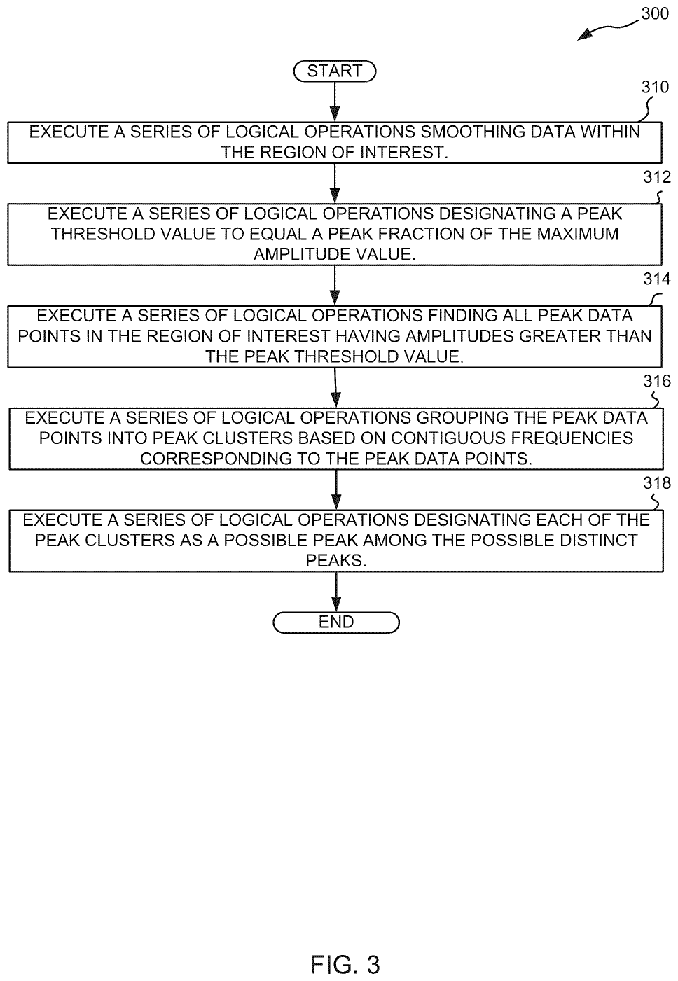

In an embodiment, the identifying the possible distinct peaks includes (a) executing, by the computer system, a series of logical operations smoothing data within the region of interest, (b) executing, by the computer system, a series of logical operations designating a peak threshold value to equal a peak fraction of the maximum amplitude value, (c) executing, by the computer system, a series of logical operations finding all peak data points in the region of interest having amplitudes greater than the peak threshold value, (d) executing, by the computer system, a series of logical operations grouping the peak data points into peak clusters based on contiguous frequencies corresponding to the peak data points, and (c) executing, by the computer system, a series of logical operations designating each of the peak clusters as a possible peak among the possible distinct peaks. Referring to FIG. 3, in an embodiment, identifying operation 116 includes an operation 310 of executing, by the computer system, a series of logical operations smoothing data within the region of interest, an operation 312 of executing, by the computer system, a series of logical operations designating a peak threshold value to equal a peak fraction of the maximum amplitude value, an operation 314 of executing, by the computer system, a series of logical operations finding all peak data points in the region of interest having amplitudes greater than the peak threshold value, an operation 316 of executing, by the computer system, a series of logical operations grouping the peak data points into peak clusters based on contiguous frequencies corresponding to the peak data points, and an operation 318 of executing, by the computer system, a series of logical operations designating each of the peak clusters as a possible peak among the possible distinct peaks. In an embodiment, the smoothing includes executing, by the computer system, a series of logical operations smoothing the data within the region of interest, with an averaging window that is 2 data points wide. In an embodiment, the peak fraction is ⅓.

In an embodiment, the computer system is a computer system 800 as shown in FIG. 8, that executes a purifying a sample solution via real-time multi-angle light scattering script or computer software application that carries out the operations of at least method 300. In an embodiment, the computer system is a computer system/server 812 as shown in FIG. 8, that executes a purifying a sample solution via real-time multi-angle light scattering script or computer software application that carries out the operations of at least method 300. In an embodiment, the computer system is a processing unit 816 as shown in FIG. 8, that executes a purifying a sample solution via real-time multi-angle light scattering script or computer software application that carries out the operations of at least method 300.

In an embodiment, the computer system is a computer system 800 as shown in FIG. 8, that executes a calculating electrophoretic mobility of a sample script or computer software application that carries out at least operations 310, 312, 314, 316, and 318. In an embodiment, the computer system is a computer system/server 812 as shown in FIG. 8, that executes a calculating electrophoretic mobility of a sample script or computer software application that carries out at least operations 310, 312, 314, 316, and 318. In an embodiment, the computer system is a processing unit 816 as shown in FIG. 8, that a calculating electrophoretic mobility of a sample script or computer software application that carries out at least operations 310, 312, 314, 316, and 318.

### Finding Initial Parameters

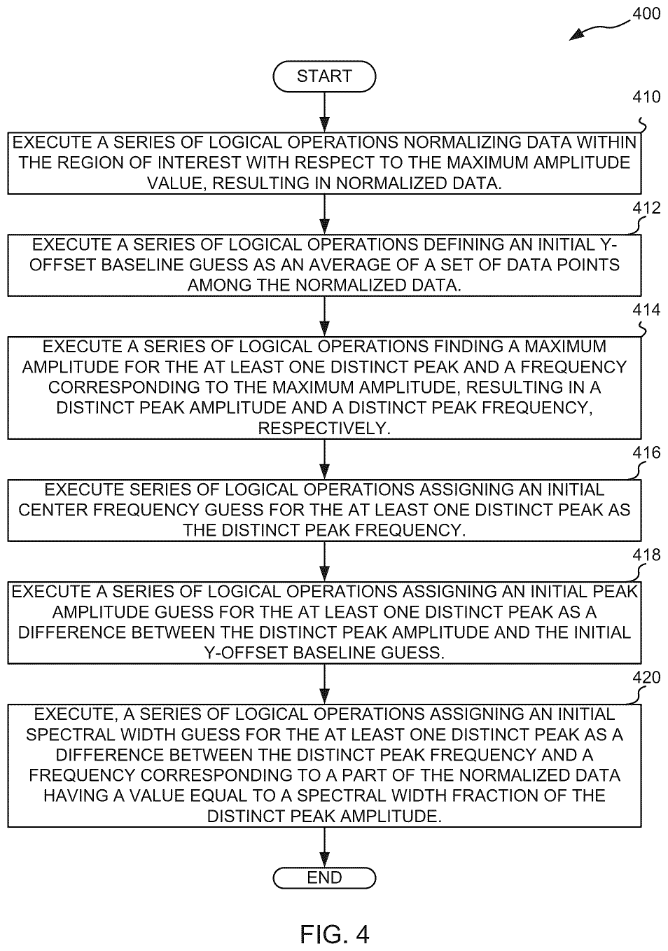

In an embodiment, the finding the initial parameters includes (a) executing, by the computer system, a series of logical operations normalizing data within the region of interest with respect to the maximum amplitude value, resulting in normalized data, (b) executing, by the computer system, a series of logical operations defining an initial y-offset baseline guess as an average of a set of data points among the normalized data, (c) executing, by the computer system, a series of logical operations finding a maximum amplitude for the at least one distinct peak and a frequency corresponding to the maximum amplitude, resulting in a distinct peak amplitude and a distinct peak frequency, respectively, (d) executing, by the computer system, a series of logical operations assigning an initial center frequency guess for the at least one distinct peak as the distinct peak frequency, (c) executing, by the computer system, a series of logical operations assigning an initial peak amplitude guess for the at least one distinct peak as a difference between the distinct peak amplitude and the initial y-offset baseline guess, and (f) executing, by the computer system, a series of logical operations assigning an initial spectral width guess for the at least one distinct peak as a difference between the distinct peak frequency and a frequency corresponding to a part of the normalized data having a value equal to a spectral width fraction of the distinct peak amplitude. Referring to FIG. 4, in an embodiment, finding operation 118 includes an operation 410 of executing, by the computer system, a series of logical operations normalizing data within the region of interest with respect to the maximum amplitude value, resulting in normalized data, an operation 412 of executing, by the computer system, a series of logical operations defining an initial y-offset baseline guess as an average of a set of data points among the normalized data, an operation 414 of executing, by the computer system, a series of logical operations finding a maximum amplitude for the at least one distinct peak and a frequency corresponding to the maximum amplitude, resulting in a distinct peak amplitude and a distinct peak frequency, respectively, an operation 416 of executing, by the computer system, a series of logical operations assigning an initial center frequency guess for the at least one distinct peak as the distinct peak frequency, an operation 418 of executing, by the computer system, a series of logical operations assigning an initial peak amplitude guess for the at least one distinct peak as a difference between the distinct peak amplitude and the initial y-offset baseline guess, and an operation 420 of executing, by the computer system, a series of logical operations assigning an initial spectral width guess for the at least one distinct peak as a difference between the distinct peak frequency and a frequency corresponding to a part of the normalized data having a value equal to a spectral width fraction of the distinct peak amplitude.

In an embodiment, the normalizing includes dividing, by the computer system, the data within the region of interest by the maximum amplitude value. In an embodiment, the set of data points includes 20 data points from the region of interest. For example, the average set of data points are the first 20 data points in the region of interest, such that there is enough data points to distinguish the data from noise, but not so much data points to interfere with the light intensity detector data. In an embodiment, the spectral width fraction is ½.

In an embodiment, the computer system is a computer system 800 as shown in FIG. 8, that executes a purifying a sample solution via real-time multi-angle light scattering script or computer software application that carries out the operations of at least method 400. In an embodiment, the computer system is a computer system/server 812 as shown in FIG. 8, that executes a purifying a sample solution via real-time multi-angle light scattering script or computer software application that carries out the operations of at least method 400. In an embodiment, the computer system is a processing unit 816 as shown in FIG. 8, that executes a purifying a sample solution via real-time multi-angle light scattering script or computer software application that carries out the operations of at least method 400.

In an embodiment, the computer system is a computer system 800 as shown in FIG. 8, that executes a calculating electrophoretic mobility of a sample script or computer software application that carries out at least operations 410, 412, 414, 416, 418, and 420. In an embodiment, the computer system is a computer system/server 812 as shown in FIG. 8, that executes a calculating electrophoretic mobility of a sample script or computer software application that carries out at least operations 410, 412, 414, 416, 418, and 420. In an embodiment, the computer system is a processing unit 816 as shown in FIG. 8, that a calculating electrophoretic mobility of a sample script or computer software application that carries out at least operations 410, 412, 414, 416, 418, and 420.

### Selecting Selected Fitting Model

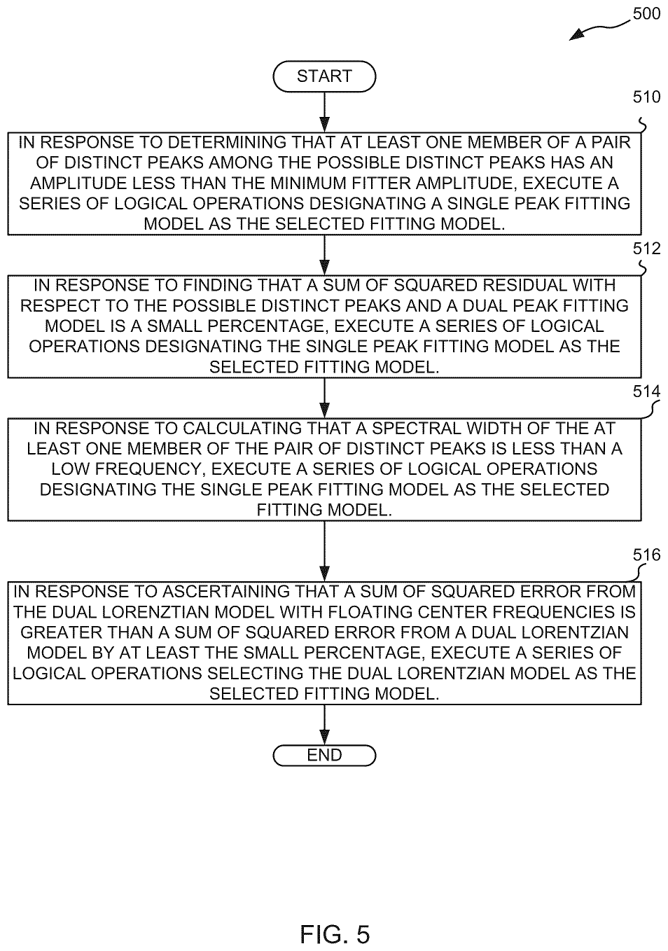

In an embodiment, the selecting the selected fitting model includes executing, by the computer system, a series of logical operations designating a dual Lorentzian Model with floating center frequencies among the plurality of fitting models as the selected fitting model, subject to executing, by the computer system, a series of logical operations testing a remainder of the plurality of fitting models. In an embodiment, the testing includes (a) in response to determining that at least one member of a pair of distinct peaks among the possible distinct peaks has an amplitude less than the minimum fitter amplitude, executing, by the computer system, a series of logical operations designating a single peak fitting model as the selected fitting model, (b) in response to finding that a sum of squared residual with respect to the possible distinct peaks and a dual peak fitting model is a small percentage, executing, by the computer system, a series of logical operations designating the single peak fitting model as the selected fitting model, (c) in response to calculating that a spectral width of the at least one member of the pair of distinct peaks is less than a low frequency, executing, by the computer system, a series of logical operations designating the single peak fitting model as the selected fitting model, and (d) in response to ascertaining that a sum of squared error from the dual Lorentzian model with floating center frequencies is greater than a sum of squared error from a dual Lorentzian model by at least the small percentage, executing, by the computer system, a series of logical operations selecting the dual Lorentzian model as the selected fitting model. Referring to FIG. 5, in an embodiment, the testing includes an operation 510 of in response to determining that at least one member of a pair of distinct peaks among the possible distinct peaks has an amplitude less than the minimum fitter amplitude, executing, by the computer system, a series of logical operations designating a single peak fitting model as the selected fitting model, an operation 512 of in response to finding that a sum of squared residual with respect to the possible distinct peaks and a dual peak fitting model is a small percentage, executing, by the computer system, a series of logical operations designating the single peak fitting model as the selected fitting model, an operation 514 of in response to calculating that a spectral width of the at least one member of the pair of distinct peaks is less than a low frequency, executing, by the computer system, a series of logical operations designating the single peak fitting model as the selected fitting model, and an operation 516 of in response to ascertaining that a sum of squared error from the dual Lorentzian Model with floating center frequencies is greater than a sum of squared error from a dual

Lorentzian Model by at least the small percentage, executing, by the computer system, a series of logical operations selecting the dual Lorentzian Model as the selected fitting model.

In an embodiment, the small percentage is selected from the group consisting of 1% and 2%. For example, the small percentage is big enough difference so that the fitting model has a lower error because it models the data capturing and actual light intensity detector signal, not spurious noise. In an embodiment, the low frequency is 1 Hz (e.g., 0.2 Hz could correspond to a 400 nm particle, leading to spurious peaks.

In an embodiment, the single peak fitting model includes a clean, single peak (i.e., a single Lorentzian fitting model). In an embodiment, the dual Lorentzian fitting model corresponds to a peak that is contaminated by another source, with a fixed center frequency, f_{c}. In an embodiment, the dual Lorentzian with floating center frequency, f_{c}, fitting model corresponds to a peak that is contaminated by another source without a fixed center frequency, f_{c}. In an embodiment, the plurality of fitting models includes a multiple Lorentzian with multiple center frequencies and multiple amplitudes fitting model.

In an embodiment, the computer system is a computer system 800 as shown in FIG. 8, that executes a purifying a sample solution via real-time multi-angle light scattering script or computer software application that carries out the operations of at least method 500. In an embodiment, the computer system is a computer system/server 812 as shown in FIG. 8, that executes a purifying a sample solution via real-time multi-angle light scattering script or computer software application that carries out the operations of at least method 500. In an embodiment, the computer system is a processing unit 816 as shown in FIG. 8, that executes a purifying a sample solution via real-time multi-angle light scattering script or computer software application that carries out the operations of at least method 500.

In an embodiment, the computer system is a computer system 800 as shown in FIG. 8, that executes a calculating electrophoretic mobility of a sample script or computer software application that carries out at least operations 510, 512, 514, and 516. In an embodiment, the computer system is a computer system/server 812 as shown in FIG. 8, that executes a calculating electrophoretic mobility of a sample script or computer software application that carries out at least operations 510, 512, 514, and 516. In an embodiment, the computer system is a processing unit 816 as shown in FIG. 8, that a calculating electrophoretic mobility of a sample script or computer software application that carries out at least operations 510, 512, 514, and 516.

### Example

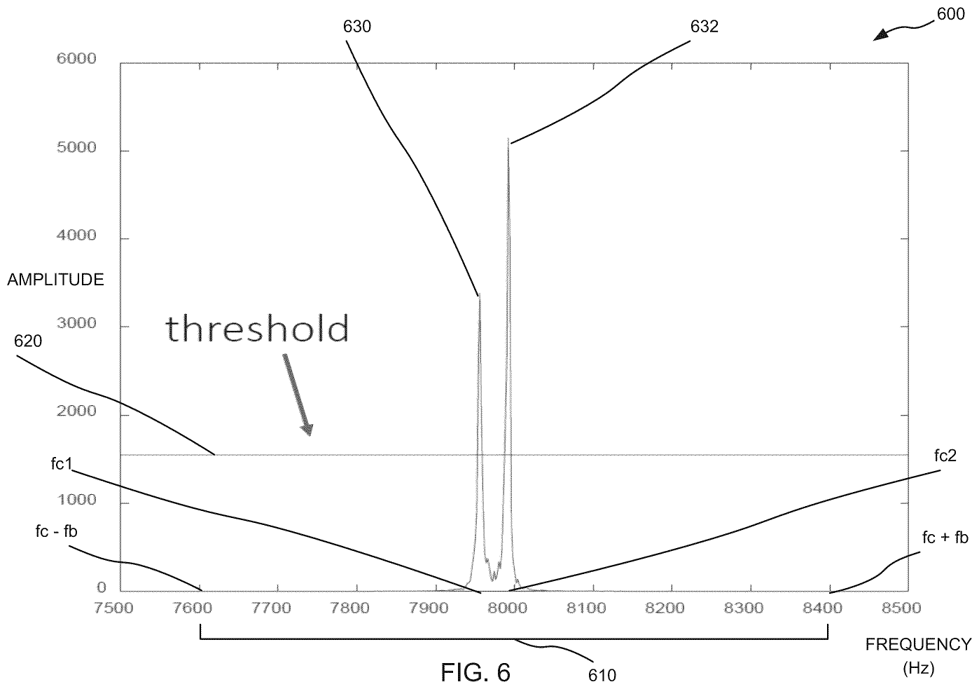

For example, FIG. 6 depicts a spectrum 600 with a region of interest 610 having a boundary frequency, f_{b}, of about 400 Hz on either side of center frequencies, f_{c}, of about 7.950 kHz, a first center frequency, f_{c1}, and 7.990 kHz, a second center frequency, f_{c2}, as determined by truncating operation 112. FIG. 6 also depicts, for example, a minimum fitter amplitude/threshold, 620, of about 1600, as determined by establishing operation 114, and possible distinct peaks 630 and 632, as determined by identifying operation 116.

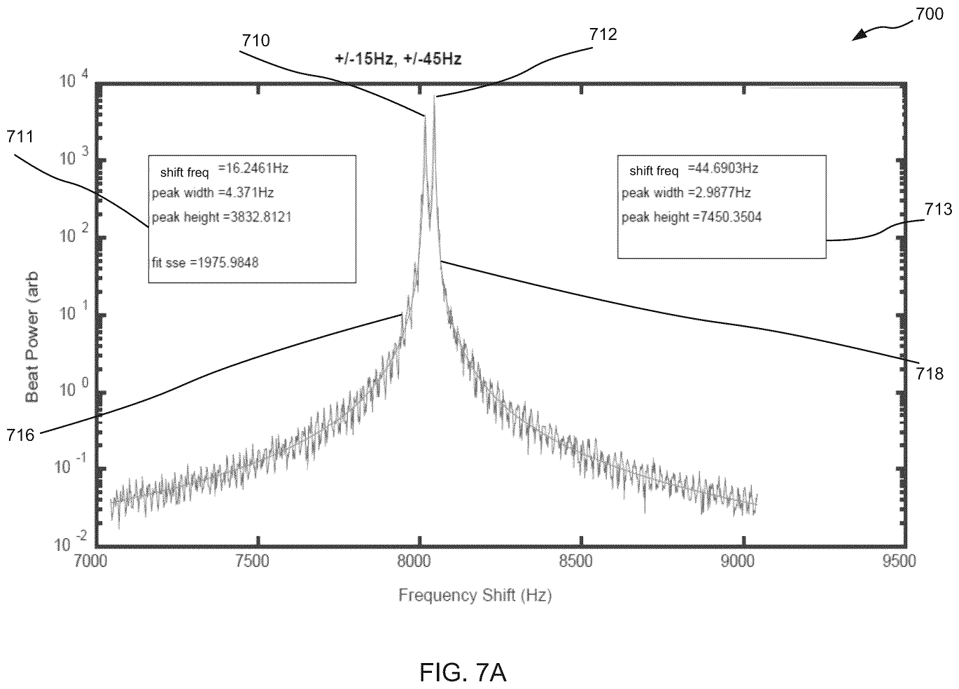

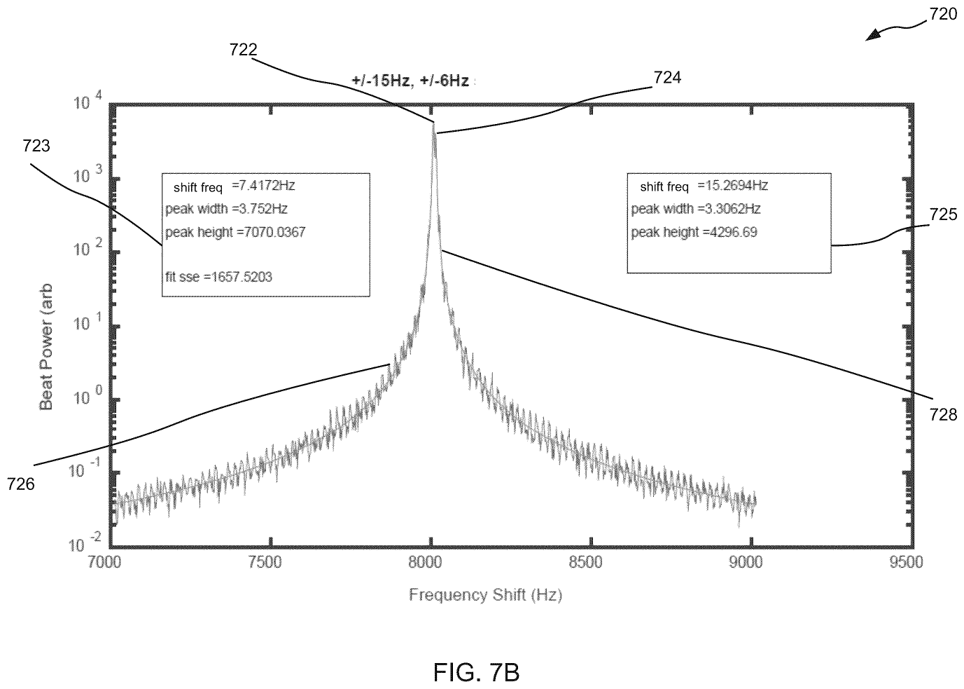

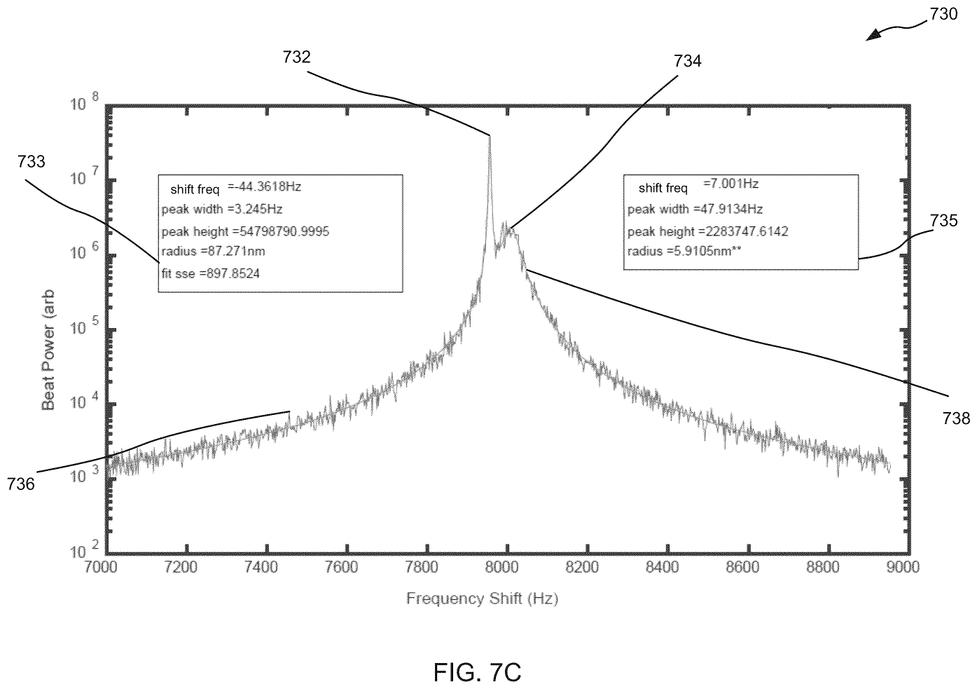

Also, for example, FIG. 7A, FIG. 7B, and FIG. 7C depict fit 700, fit 720, and fit 730, respectively, accomplished by fitting operation 122. FIG. 7A, for example, shows a multi-species fit 700, with one species corresponding to a peak 710, having a mobility that corresponds to a frequency shift of approximately 16 Hz (as noted in detail box 711), and a second species corresponding to a peak 712, having a mobility that corresponds to a frequency shift of approximately 45 Hz (as noted in detail box 713), as determined by using the dual Lorentzian with floating center frequency fitting model to fit received spectrum data 716 into fitted data 718. FIG. 7B, for example, depicts a multi-species fit 720, with one species corresponding to a peak 722, having a mobility that corresponds to a frequency shift of approximately 7 Hz (as noted in detail box 723), and a second species corresponding to a peak 724 having a mobility that corresponds to a frequency shift of approximately 15 Hz (as noted in detail box 725), as determined by using the dual Lorentzian with floating center frequency fitting model to fit received spectrum data 726 into fitted data 728. Even though the shifts corresponding to peak 722 and peak 724 are much closer to each other, fitting operation 122 is able to distinguish between the shifts, for example.

In another example, FIG. 7C depicts a multi-species fit 730, with one species corresponding to a peak 732 having a mobility that corresponds to a frequency shift of approximately 45 Hz (as noted in detail box 733), and a second species corresponding to a peak 734 having a mobility that corresponds to a frequency shift of approximately 7 Hz (as noted in detail box 735), as determined by using the dual Lorentzian with floating center frequency fitting model to fit received spectrum data 736 into fitted data 738. Fit 730 shows that the two species corresponding to peaks 732 and 734, respectively, have very different sizes, leading to very different widths of the spectra corresponding to peaks 732 and 734. For example, fitting operation 122 is able to distinguish a smaller particle with its approximately 7 Hz shift (indicated by peak 734) from a larger particle whose frequency shift is approximately 45 Hz (indicated by peak 732).

### Computer System

In an exemplary embodiment, the computer system is a computer system 800 as shown in FIG. 8. Computer system 800 is only one example of a computer system and is not intended to suggest any limitation as to the scope of use or functionality of embodiments of the present disclosure. Regardless, computer system 800 is capable of being implemented to perform and/or performing any of the functionality/operations of the present disclosure.

Computer system 800 includes a computer system/server 812, which is operational with numerous other general purpose or special purpose computing system environments or configurations. Examples of well-known computing systems, environments, and/or configurations that may be suitable for use with computer system/server 812 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices.

Computer system/server 812 may be described in the general context of computer system-executable instructions, such as program modules, being executed by a computer system. Generally, program modules may include routines, programs, objects, components, logic, and/or data structures that perform particular tasks or implement particular abstract data types. Computer system/server 812 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 8, computer system/server 812 in computer system 800 is shown in the form of a general-purpose computing device. The components of computer system/server 812 may include, but are not limited to, one or more processors or processing units 816, a system memory 828, and a bus 818 that couples various system components including system memory 828 to processor 816.

Bus 818 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 812 typically includes a variety of computer system readable media. Such media may be any available media that is accessible by computer system/server 812, and includes both volatile and non-volatile media, removable and non-removable media.

System memory 828 can include computer system readable media in the form of volatile memory, such as random access memory (RAM) 830 and/or cache memory 832. Computer system/server 812 may further include other removable/non-removable, volatile/non-volatile computer system storage media. By way of example only, storage system 834 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 818 by one or more data media interfaces. As will be further depicted and described below, memory 828 may include at least one program product having a set (e.g., at least one) of program modules that are configured to carry out the functions/operations of embodiments of the disclosure.

Program/utility 840, having a set (at least one) of program modules 842, may be stored in memory 828 by way of example, and not limitation. Exemplary program modules 842 may include an operating system, one or more application programs, other program modules, and program data. Each of the operating system, one or more application programs, other program modules, and program data or some combination thereof, may include an implementation of a networking environment. Program modules 842 generally carry out the functions and/or methodologies of embodiments of the present disclosure.

Computer system/server 812 may also communicate with one or more external devices 814 such as a keyboard, a pointing device, a display 824, one or more devices that enable a user to interact with computer system/server 812, and/or any devices (e.g., network card, modem, etc.) that enable computer system/server 812 to communicate with one or more other computing devices. Such communication can occur via Input/Output (I/O) interfaces 822. Still yet, computer system/server 812 can communicate with one or more networks such as a local area network (LAN), a general wide area network (WAN), and/or a public network (e.g., the Internet) via network adapter 820. As depicted, network adapter 820 communicates with the other components of computer system/server 812 via bus 818. It should be understood that although not shown, other hardware and/or software components could be used in conjunction with computer system/server 812. Examples, include, but are not limited to: microcode, device drivers, redundant processing units, external disk drive arrays, RAID systems, tape drives, and data archival storage systems.

### Computer Program Product

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

What is claimed is:

1. A computer-implemented method comprising:
receiving, by a computer system, at least one frequency domain spectrum relating to light intensity detector data corresponding to a sample;
executing, by a computer system, a series of logical operations truncating the spectrum to a region of interest with respect to a spectrum center frequency associated with the spectrum;
executing, by the computer system, a series of logical operations establishing a minimum fitter amplitude for what constitutes a peak in the region of interest;
executing, by the computer system, a series of logical operations identifying possible distinct peaks in the region of interest with respect to the minimum fitter amplitude and a maximum amplitude value associated with the region of interest;
executing, by the computer system, a series of logical operations finding initial parameters for fitting at least one distinct peak among the possible distinct peaks with respect to the maximum amplitude value;
executing, by the computer system, a series of logical operations selecting a selected fitting model from among a plurality of fitting models with respect to the possible distinct peaks; and
executing, by the computer system, a series of logical operations fitting the at least one distinct peak to the selected fitting model a series of logical operations fitting the at least one distinct peak to the selected fitting model resulting in at least one fitted signal peak corresponding to the light intensity detector data, allowing for calculating electrophoretic mobility of particles of the sample.

2. The method of claim 1 wherein the region of interest comprises
parts of the spectrum having frequencies greater than a sum of the spectrum center frequency and a boundary frequency and having frequencies less than a difference between the spectrum center frequency and the boundary frequency,
wherein the boundary frequency is less than a shift frequency associated with the spectrum.

3. The method of claim 2 wherein the boundary frequency is less than one-half of the shift frequency.

4. The method of claim 1 wherein the calculating the electrophoretic mobility comprises:
executing, by the computer system, a series of logical operations finding a peak center frequency of the at least one fitted signal peak; and
executing, by the computer system, a series of logical operations measuring a shift frequency from the at least one fitted signal peak,
wherein the shift frequency corresponds to an amount that the peak center frequency has shifted, and
wherein the shift frequency is proportional to the electrophoretic mobility of the particles in the sample.

5. The method of claim 1 wherein the establishing the minimum fitter amplitude comprises:
executing, by the computer system, a series of logical operations selecting parts of the spectrum having frequencies outside of the region of interest, resulting in outside parts of the spectrum;
calculating, by the computer system, a histogram across the outside parts of the spectrum, resulting in a cumulative relative number of observations in each bin in the histogram and in all previous bins in the histogram;
receiving, by the computer system, a threshold percentage from a data store;
executing, by the computer system, a series of logical operations finding a threshold bin in the histogram that contains a threshold number of observations corresponding to a percentage of data in the outside parts of the spectrum equal to the threshold percentage;
executing, by the computer system, a series of logical operations designating the minimum fitter amplitude to be the threshold number of observations multiplied by a threshold factor.

6. The method of claim 5 wherein the threshold factor is 5.

7. The method of claim 1 wherein the identifying the possible distinct peaks comprises:
executing, by the computer system, a series of logical operations smoothing data within the region of interest;
executing, by the computer system, a series of logical operations designating a peak threshold value to equal a peak fraction of the maximum amplitude value;
executing, by the computer system, a series of logical operations finding all peak data points in the region of interest having amplitudes greater than the peak threshold value;
executing, by the computer system, a series of logical operations grouping the peak data points into peak clusters based on contiguous frequencies corresponding to the peak data points; and
executing, by the computer system, a series of logical operations designating each of the peak clusters as a possible peak among the possible distinct peaks.

8. The method of claim 7 wherein the smoothing comprises executing, by the computer system, a series of logical operations smoothing the data within the region of interest, with an averaging window that is 2 data points wide.

9. The method of claim 7 wherein the peak fraction is ⅓.

10. The method of claim 1 wherein the finding the initial parameters comprises:
executing, by the computer system, a series of logical operations normalizing data within the region of interest with respect to the maximum amplitude value, resulting in normalized data;
executing, by the computer system, a series of logical operations defining an initial y-offset baseline guess as an average of a set of data points among the normalized data;
executing, by the computer system, a series of logical operations finding a maximum amplitude for the at least one distinct peak and a frequency corresponding to the maximum amplitude, resulting in a distinct peak amplitude and a distinct peak frequency, respectively;
executing, by the computer system, a series of logical operations assigning an initial center frequency guess for the at least one distinct peak as the distinct peak frequency;
executing, by the computer system, a series of logical operations assigning an initial peak amplitude guess for the at least one distinct peak as a difference between the distinct peak amplitude and the initial y-offset baseline guess; and
executing, by the computer system, a series of logical operations assigning an initial spectral width guess for the at least one distinct peak as a difference between the distinct peak frequency and a frequency corresponding to a part of the normalized data having a value equal to a spectral width fraction of the distinct peak amplitude.

11. The method of claim 10 wherein the normalizing comprises
dividing, by the computer system, the data within the region of interest by the maximum amplitude value.

12. The method of claim 10 wherein the set of data points comprises 20 data points from the region of interest.

13. The method of claim 10 wherein the spectral width fraction is ½.

14. The method of claim 1 wherein the selecting the selected fitting model comprises:
executing, by the computer system, a series of logical operations designating a dual Lorentzian model with floating center frequencies among the plurality of fitting models as the selected fitting model, subject to executing, by the computer system, a series of logical operations testing a remainder of the plurality of fitting models.

15. The method of claim 14 wherein the testing comprises:
in response to determining that at least one member of a pair of distinct peaks among the possible distinct peaks has an amplitude less than the minimum fitter amplitude, executing, by the computer system, a series of logical operations designating a single peak fitting model as the selected fitting model;
in response to finding that a sum of squared residual with respect to the possible distinct peaks and a dual peak fitting model is a small percentage, executing, by the computer system, a series of logical operations designating the single peak fitting model as the selected fitting model;
in response to calculating that a spectral width of the at least one member of the pair of distinct peaks is less than a low frequency, executing, by the computer system, a series of logical operations designating the single peak fitting model as the selected fitting model; and
in response to ascertaining that a sum of squared error from the dual Lorentzian model with floating center frequencies is greater than a sum of squared error from a dual Lorentzian model by at least the small percentage, executing, by the computer system, a series of logical operations selecting the dual Lorentzian model as the selected fitting model.

16. The method of claim 15 wherein the small percentage is selected from the group consisting of 1% and 2%.

17. The method of claim 15 wherein the low frequency is 1 Hz.

18. A system comprising:
a memory; and
a processor in communication with the memory, the processor configured to perform a method comprising
receiving at least one frequency domain spectrum relating to light intensity detector data corresponding to a sample,
executing a series of logical operations truncating the spectrum to a region of interest with respect to a spectrum center frequency associated with the spectrum,
executing a series of logical operations establishing a minimum fitter amplitude for what constitutes a peak in the region of interest,
executing a series of logical operations identifying possible distinct peaks in the region of interest with respect to the minimum fitter amplitude and a maximum amplitude value associated with the region of interest,
executing a series of logical operations finding initial parameters for fitting at least one distinct peak among the possible distinct peaks with respect to the maximum amplitude value,
executing a series of logical operations selecting a selected fitting model from among a plurality of fitting models with respect to the possible distinct peaks, and
executing, by the computer system, a series of logical operations fitting the at least one distinct peak to the selected fitting model a series of logical operations fitting the at least one distinct peak to the selected fitting model resulting in at least one fitted signal peak corresponding to the light intensity detector data, allowing for calculating electrophoretic mobility of particles of the sample.

19. The system of claim 18 wherein the region of interest comprises
parts of the spectrum having frequencies greater than a sum of the spectrum center frequency and a boundary frequency and having frequencies less than a difference between the spectrum center frequency and the boundary frequency,
wherein the boundary frequency is less than a shift frequency associated with the spectrum.

20. A computer program product comprising a computer readable storage medium having program instructions embodied therewith, the program instructions executable by a processor to cause the processor to perform a method comprising:
receiving at least one frequency domain spectrum relating to light intensity detector data corresponding to a sample;
executing a series of logical operations truncating the spectrum to a region of interest with respect to a spectrum center frequency associated with the spectrum;
executing a series of logical operations establishing a minimum fitter amplitude for what constitutes a peak in the region of interest;
executing a series of logical operations identifying possible distinct peaks in the region of interest with respect to the minimum fitter amplitude and a maximum amplitude value associated with the region of interest;
executing a series of logical operations finding initial parameters for fitting at least one distinct peak among the possible distinct peaks with respect to the maximum amplitude value;
executing a series of logical operations selecting a selected fitting model from among a plurality of fitting models with respect to the possible distinct peaks; and
executing a series of logical operations fitting the at least one distinct peak to the selected fitting model a series of logical operations fitting the at least one distinct peak to the selected fitting model resulting in at least one fitted signal peak corresponding to the light intensity detector data, allowing for calculating electrophoretic mobility of particles of the sample.
